(19) United States
(12) Patent Application Publication
(10) Pub. No.: US 2009/0322897 A1
(43) Pub. Date: Dec. 31, 2009

(54) DIGITAL IMAGE PROCESSING APPARATUS HAVING SELF-NAVIGATOR FUNCTION, AND OPERATION METHOD OF THE DIGITAL IMAGE PROCESSING APPARATUS

(75) Inventor: Su-jung Park, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/489,540

(22) Filed: Jun. 23, 2009

(30) Foreign Application Priority Data
Jun. 26, 2008 (KR) 10-2008-0061122

(51) Int. Cl. H04N 5/228; G06K 9/00

(52) U.S. Cl. 348/222.1; 382/118; 348/E05.031

(57) ABSTRACT

A digital image processing apparatus and method are provided, particularly, a digital image processing apparatus having a self-navigator function for allowing capture of a self-image with a user-desired composition, and an operation method of the digital image processing apparatus. The digital image processing apparatus includes a digital signal processing unit for setting a desired position at which a subject is to be positioned on a live-view image and directing the subject to move until an actual position of the subject corresponds to the desired position.

### CROSS-REFERENCE TO RELATED PATENT APPLICATION

This application claims the benefit of Korean Patent Application No. 10-2008-0061122, filed on Jun. 26, 2008, in the Korean Intellectual Property Office, the disclosure of which is incorporated herein in its entirety by reference.

### BACKGROUND

The present invention relates to a digital image processing apparatus and method, and more particularly, to a digital image processing apparatus having a self-navigator function for allowing capture of a self-image with a user-desired composition, and an operation method of the digital image processing apparatus. Generally, a user can capture an image of him/herself (hereinafter referred to as a “self-image”) by positioning an image capturing device using a reflective material providing a mirror effect adjacent to a lens, or with the aid of a beeping sound generated by a face recognition mechanism when a face is located in the middle of a screen.

However, as the size of a background on a self-image is increased, the composition and the arrangement between a subject and a background have become more important. Accordingly, a digital image processing apparatus requires a new self-navigator function for more accurately arranging a subject and a background into a user-desired composition to be developed over the existing self-navigator function that mainly aims to put the whole face of a photographer in the middle of an image.

### SUMMARY

The present invention provides a digital image processing apparatus having a self-navigator function for allowing capture of a self-image with a user-desired composition, and an operation method of the digital image processing apparatus.

According to an aspect of the present invention, there is provided a digital image processing apparatus having a self-navigator function, the apparatus including a digital signal processing unit for setting a desired position at which a subject is to be positioned on a live-view image and directing the subject to move until an actual position of the subject corresponds to the desired position.

The apparatus may further include a direction unit for outputting a visual signal or an audible signal in order to direct the subject to move.

The digital signal processing unit may include a position setting unit for setting the desired position at which the subject is to be positioned on the live-view image; a face recognition unit for calculating a face position of the subject on the live-view image; a position determination unit for determining whether the face position corresponds to the desired position; and a control unit for outputting direction signals to the direction unit until the face position corresponds to the desired position.

According to another aspect of the present invention, there is provided an operation method of a digital image processing apparatus having a self-navigator function, the method including receiving a signal for setting a desired position at which a subject is to be positioned on a live-view image; calculating an actual position of the subject on the live-view image; and directing the subject to move until the actual position of the subject corresponds to the desired position.

A visual signal or an audible signal may be output in order to direct the subject to move.

The actual position of the subject may be a face position of the subject, which is calculated by performing face recognition.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a digital image processing apparatus according to an embodiment of the present invention;

FIG. 2 is a rear view of the digital image processing apparatus illustrated in FIG. 1, according to an embodiment of the present invention;

FIG. 3 is a block diagram of a digital image processing apparatus having a self-navigator function, according to an embodiment of the present invention;

FIGS. 4A through 4E are pictorial diagrams of the display and camera for describing a method of capturing a self-image by implementing a self-navigator function of the digital image processing apparatus illustrated in FIG. 3, according to an embodiment of the present invention; and

FIG. 5 is a flowchart of an operation method of a digital image processing apparatus having a self-navigator function, according to an embodiment of the present invention.

### DETAILED DESCRIPTION OF THE PREFERRED EMBODIMENTS

Hereinafter, the present invention will be described in detail by explaining embodiments of the invention with reference to the attached drawings.

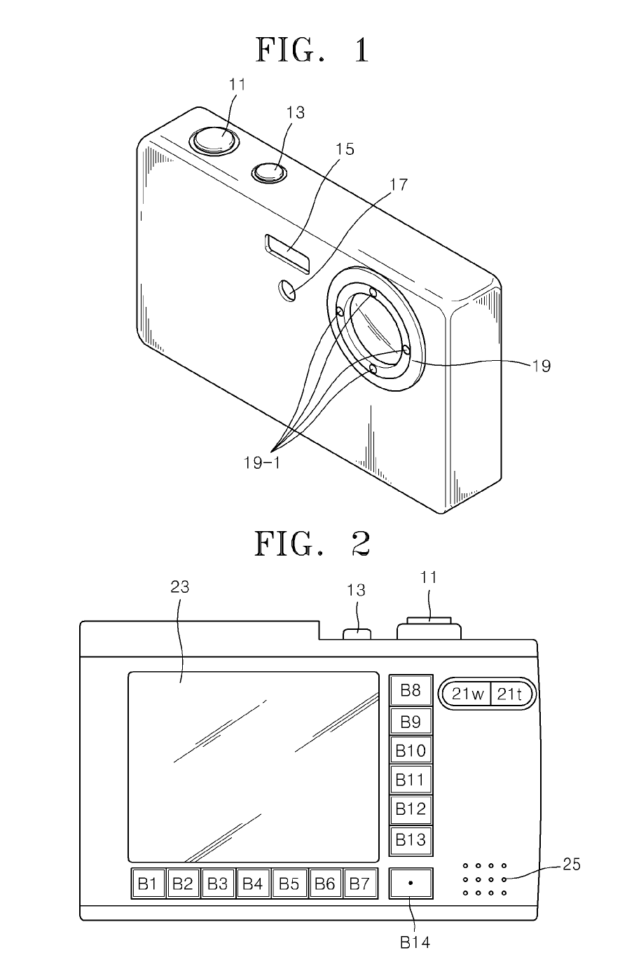

FIG. 1 is a perspective view of a digital image processing apparatus according to an embodiment of the present invention.

Referring to FIG. 1, a shutter-release button 11 opens or shuts a shutter (not shown) such that a charge-coupled device (CCD) (not shown) or a film (not shown) is exposed to light for a predetermined period of time and a subject is recorded on the CCD as an image.

The shutter-release button 11 creates first and second image capture signals based on a user's input. When the shutter-release button 11 is half-pressed the first image capture signal is generated, and the digital image processing apparatus focuses on the subject and controls the amount of light. In this case, if the digital image processing apparatus is in focus, a green light is turned on. After that, if the shutter-release button 11 is fully pressed the second image capture signal is generated so as to capture the image.

A power button 13 provides power to the digital image processing apparatus so as to operate the digital image processing apparatus.

A flash 15 instantly flashes bright light when in a dark environment so as to illuminate the subject. Flash modes include an automatic flash mode, a flash on mode, a flash off mode, a red-eye reduction mode, a slow synchro mode, etc.

An auxiliary light source 17 provides light to the subject when the amount of light is not sufficient or when the subject is photographed at night, so that the digital image processing apparatus can easily and accurately focus on the subject.

A lens unit 19 receives light from an external light source and processes the image.

Light emitting diodes (LEDs) 19-1 are included in the lens unit 19 and direct the subject to move. For example, as illustrated in FIG. 1, four LEDs 19-1 may be included. A left LED 19-1 may be turned on as a direction signal to direct the subject to move to the left, a right LED 19-1 may be turned on as a direction signal to direct the subject to move to the right, an upper LED 19-1 may be turned on as a direction signal to direct the subject to move upward, and a lower LED 19-1 may be turned on as a direction signal to direct the subject to move downward. If a current position of the subject corresponds to a desired position set by the user, all of the four LEDs 19-1 may be turned on or off so as to direct a photographer to capture a self-image.

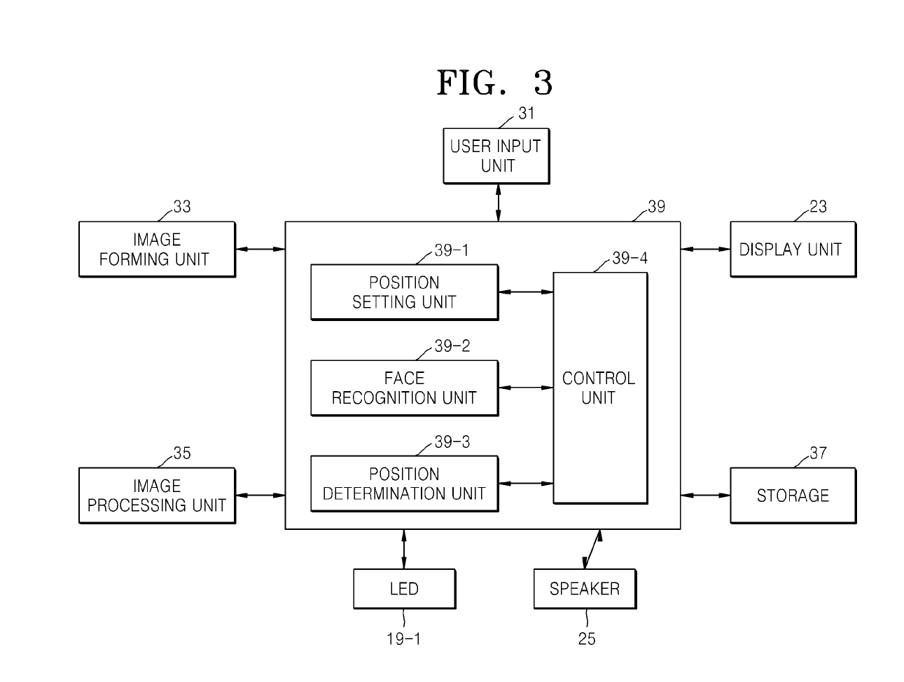

FIG. 2 is a rear view of the digital image processing apparatus illustrated in FIG. 1, according to an embodiment of the present invention.

Referring to FIG. 2, the digital image processing apparatus includes a wide-zoom button 21w, a tele-zoom button 21t, a display unit 23, a speaker 25, and a plurality of input buttons B1 through B14 (hereinafter referred to as buttons B1 through B14).

The wide-zoom button 21w or the tele-zoom button 21t widens or narrows a viewing angle and is used to change a size of a selected exposure area. The wide-zoom button 21w is used to zoom out, that is to increase the portion of a view that is imaged by the camera and the tele-zoom button 21t is used to zoom in, that is to increase the size of a desired subject or area of interest that is imaged by the camera.

The speaker 25 audibly directs a subject to move. If the subject needs to move to the left, the speaker 25 may output a [Please move to the left] sound. If the subject needs to move to the right, the speaker 25 may output a [Please move to the right] sound. If the subject needs to move upward, the speaker 25 may output a [Please move upward] sound. If the subject needs to move downward, the speaker 25 may output a [Please move downward] sound. If a current position of the subject corresponds to a desired position set by a user, the speaker 25 may output a [The position is correct now. Please press the shutter-release button] sound so as to direct a photographer to capture a self-image.

The buttons B1 through B14 are horizontally and vertically arranged adjacent to each other on sides of the display unit 23 and may each include a touch sensor (not shown) or a contact-point switch (not shown).

In more detail, if the buttons B1 through B14 include touch sensors, for example, a color menu or a brightness menu may be selected from a main menu or an item from a sub menu or the main menu may be activated, by touching and sliding on the buttons B1 through B14.

Otherwise, if the buttons B1 through B14 include contact-point switches, a main menu or a sub-menu may be directly selected so as to execute a function corresponding to the main menu or the sub-menu. The touch sensors require a relatively soft touch in comparison to the contact-point switches.

FIG. 3 is a block diagram of a digital image processing apparatus having a self-navigator function, according to an embodiment of the present invention. FIG. 3 will be described in conjunction with FIGS. 1 and 2.

Referring to FIG. 3, the digital image processing apparatus includes the LEDs 19-1, the display unit 23, the speaker 25, a user input unit 31, an image forming unit 33, an image processing unit 35, a storage 37, and a digital signal processing unit 39.

The user input unit 31 includes the shutter-release button 11 that opens or shuts a shutter (not shown) such that a CCD (not shown) or a film (not shown) is exposed to light for a predetermined period of time, the power button 13 that provides power, the wide-zoom button 21w or the tele-zoom button 21t that widens or narrows a viewing angle, and the buttons B1 through B14 that are horizontally and vertically arranged adjacent to each other on sides of the display unit 23 and each includes a touch sensor (not shown) or a contact-point switch (not shown). The image forming unit 33 includes the shutter, the lens unit 19, an iris (not shown), the CCD, and an analog-to-digital converter (ADC) (not shown). The shutter and the iris control the amount of light to which the CCD is exposed. The lens unit 19 receives light from an external light source and processes an image. In this case, the amount of incident light is controlled based on the amount to which the iris is open or shut, as controlled by the digital signal processing unit 39.

The CCD accumulates light received by the lens unit 19 and outputs an image captured by the lens unit 19 according to the amount of accumulated light, in accordance with a vertical synchronization signal. The digital image processor captures an image by using the CCD that converts light reflected from a subject into an electric signal. A color filter is required to obtain a color image by using the CCD, and a color filter array (CFA) filter (not shown) is mainly used as the color filter. The CFA filter passes light of only one color through each pixel, has a regular arrangement structure, and has various types according to the arrangement structure. The ADC converts an analog image signal output from the CCD into a digital signal.

The image processing unit 35 performs signal processing to allow digital-converted raw data to be displayable. The image processing unit 35 removes a black level caused by a dark current generated from the CCD and the CFA that are sensitive to temperature variation. The image processing unit 35 performs gamma correction for encoding information in consideration of the nonlinearity of human vision. The image processing unit 35 performs CFA interpolation by interpolating a Bayer pattern implemented by RGRG lines and GBGB lines of predetermined gamma-corrected data, into RGB lines. The image processing unit 35 converts the interpolated RGB signal into a YUV signal, performs edge compensation for making an image clear by filtering a Y signal by using a high-pass filter, performs color correction for correcting color values of U and V signals by using a standard color coordinate system, and removes noise from the U and V signals. The image processing unit 35 performs compression and signal processing on the Y, U, and V signals from which noise is removed, and generates a JPEG file. The JPEG file is displayed on the display unit 23 and is stored in the storage 37. The image processing unit 35 operates by the control of the digital signal processing unit 39.

When a self-image is captured, the digital signal processing unit 39 sets, on a live-view image, a desired position at which a subject is to be positioned, and directs the subject to move toward the desired position. For this, the digital signal processing unit 39 includes a position setting unit 39-1, a face recognition unit 39-2, a position determination unit 39-3, and a control unit 39-4.

The digital image processing apparatus according to the current embodiment of the present invention further includes a direction unit for outputting a visual signal or an audible signal in order to direct the subject to move. The direction unit may be the LEDs 19-1 or the speaker 25. Descriptions of the LEDs 19-1 and the speaker 25 are made above with reference to FIGS. 1 and 2 and thus will be omitted here.

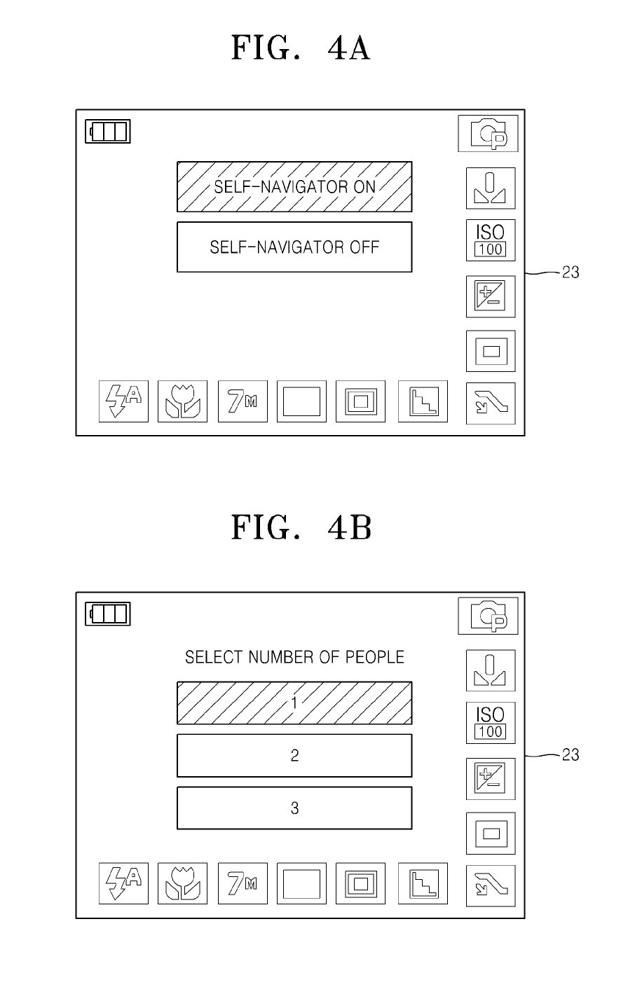

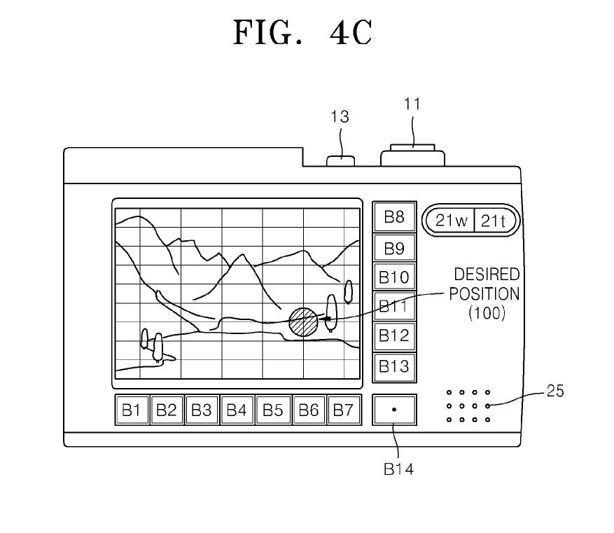

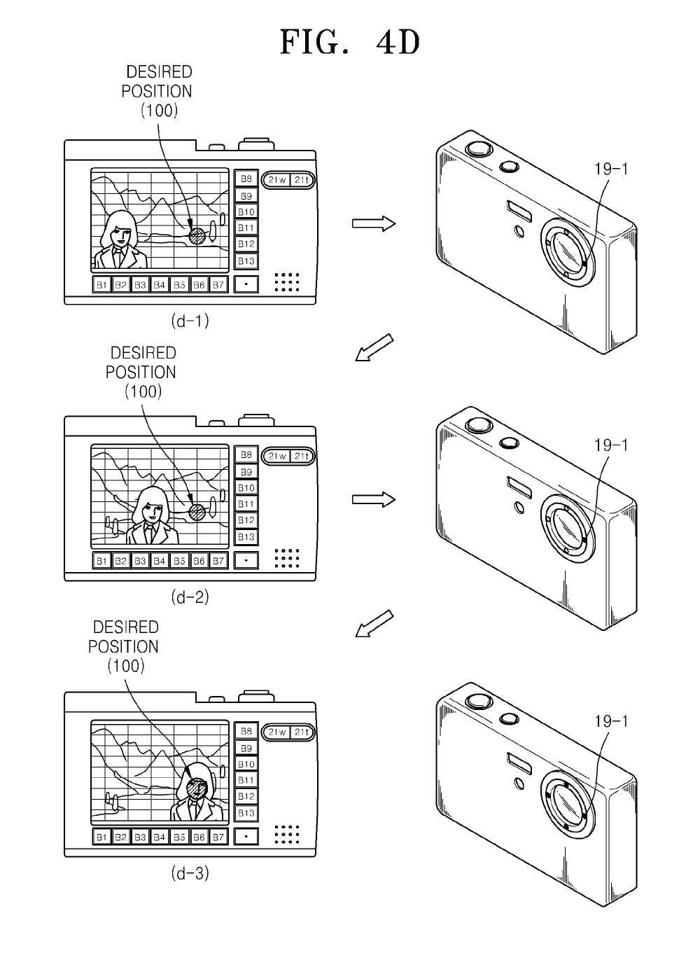

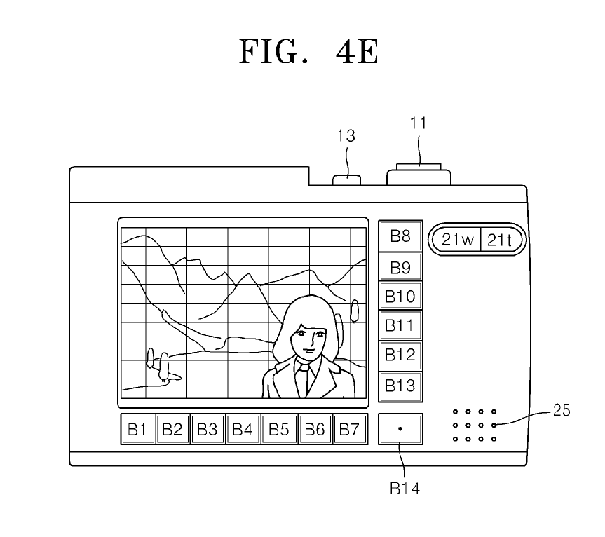

FIGS. 4A through 4E are diagrams for describing a method of capturing a self-image by implementing a self-navigator function of the digital image processing apparatus illustrated in FIG. 3, according to an embodiment of the present invention.

FIGS. 4A through 4E will be described in conjunction with FIG. 3.

FIG. 4A shows a screen of the display unit 23 for selecting a self-navigator mode.

FIG. 4B shows a screen of the display unit 23 for setting the number of people to be photographed in the self-image. After the number of people is set, a live-view image is displayed as shown in FIG. 4C. The position setting unit 39-1 sets a desired position 100 at which a subject is to be positioned on the live-view image that is a desired background. The position setting unit 39-1 provides a lattice pattern on the live-view image so as to easily set the desired position 100. The desired position 100 set by a user is stored in the control unit 39-4. The face recognition unit 39-2 calculates a face position of the subject on the live-view image. The face recognition unit 39-2 recognizes the face of the subject on the live-view image and detects face information such as a face size, face position, and a face direction of the subject, as shown in FIG. 4D. The face recognition unit 39-2 may detect the face size by detecting a face area based on color or edge information, may detect the face position by calculating a distance between a center of the detected face area and a center of the display unit 23, which is previously set, and may detect the face direction by using a triangle shape formed between eyes and a mouth in the detected face area. Face information detection algorithms, for use with the face recognition unit 39-2, are widely known and thus detailed descriptions thereof will be omitted here.

The position determination unit 39-3 determines whether the face position calculated by the face recognition unit 39-2 corresponds to the desired position 100 set by the position setting unit 39-1.

The control unit 39-4 outputs direction signals until the face position calculated by the face recognition unit 39-2 corresponds to the desired position 100 set by the position setting unit 39-1. When the face position calculated by the face recognition unit 39-2 corresponds to the desired position 100 set by the position setting unit 39-1, the control unit 39-4 may output a signal for directing a photographer to capture the self-image.

FIG. 4D shows an example when a position of the subject varies in accordance with the direction signals output from the control unit 39-4. If the face position calculated by the face recognition unit 39-2 does not correspond to the desired position 100 set by the position setting unit 39-1 as shown in FIG. 4D-1, the control unit 39-4 outputs a direction signal to direct the subject to move to the right. The direction signal is output to the LEDs 19-1, a right LED 19-1 is turned on, and then the photographer may move to the right in response to the right LED 19-1. Alternatively, the direction signal may be output to the speaker 25, the speaker 25 outputs a [Please move to the right] sound, and then the photographer may move to the right in response to the sound.

If the face position calculated by the face recognition unit 39-2 does not yet correspond to the desired position 100 set by the position setting unit 39-1 as shown in FIG. 4D-2, the control unit 39-4 continuously outputs a direction signal to the LEDs 19-1 or the speaker 25 so as to direct the subject to move. If the face position calculated by the face recognition unit 39-2 corresponds to the desired position 100 set by the position setting unit 39-1 as shown in FIG. 4D-3, the control unit 39-4 may output a position correspondence signal to the LEDs 19-1 so as to turn all of the LEDs 19-1 on or off, or to the speaker 25 so as to output a [The position is correct now. Please press the shutter-release button] sound, thereby directing the photographer to capture the self-image. Then, the photographer presses the shutter-release button 11 illustrated in FIG. 1 so as to capture the self-image. As a result, an image shown in FIG. 4E is captured and stored. Although the above description is made on the assumption that the subject is one person, the present invention may also be applied when a self-image of two or more people is captured. In this case, desired positions corresponding to the two or more people are set, a direction signal is continuously output until face positions calculated by recognizing faces of the people correspond to the desired positions, and the self-image may be captured when the face positions correspond to the desired positions.

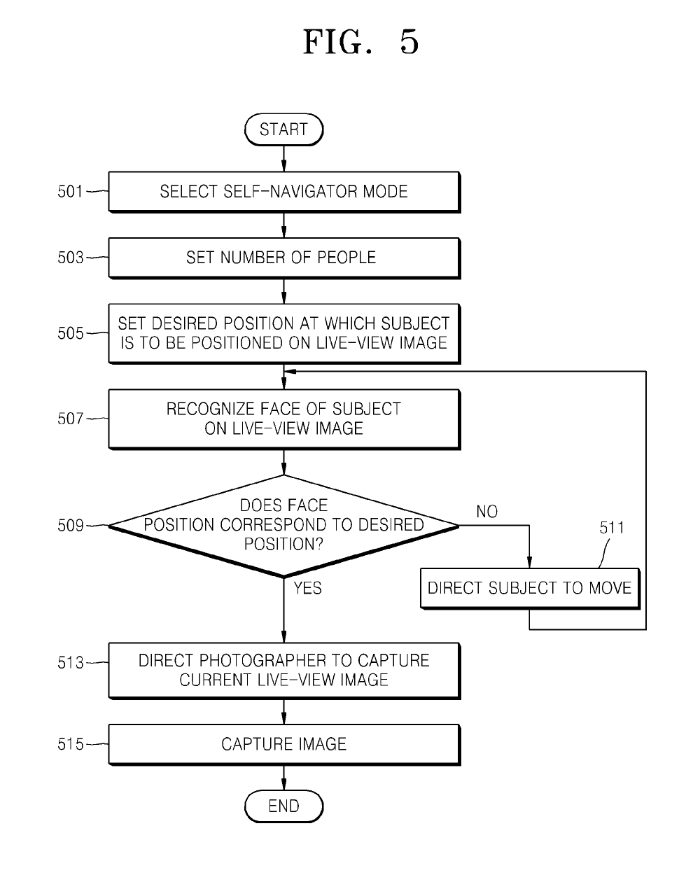

FIG. 5 is a flowchart of an operation method of a digital image processing apparatus having a self-navigator function, according to an embodiment of the present invention. The operation method may be performed by the digital image processing apparatus illustrated in FIG. 3 and a main algorithm of the operation method may be performed by the digital signal processing unit 39 illustrated in FIG. 3 with the aid of other elements included in the digital image processing apparatus.

FIG. 5 will be described in conjunction with FIGS. 3 and 4A through 4E. The digital signal processing unit 39 receives from a user a signal for selecting a self-navigator mode of the digital image processing apparatus in order to capture a self-image, in operation 501, and receives from the user a signal for setting the number of people to be photographed in the self-image, in operation 503. FIG. 4A shows a screen of the display unit 23 for selecting the self-navigator mode. FIG. 4B shows a screen of the display unit 23 for setting the number of people to be photographed in the self-image.

After the number of people is set, the digital signal processing unit 39 receives from the user a signal for setting the desired position 100 at which a subject is to be positioned on a live-view image, in operation 505. The digital signal processing unit 39 sets a desired face position of the subject on the live-view image that is a desired background shown in FIG. 4C. The digital signal processing unit 39 provides a lattice pattern on the live-view image so as to easily set the desired position 100. The desired position 100 set by the user is stored in the digital signal processing unit 39.

Then, the digital signal processing unit 39 calculates a face position of the subject on the live-view image by performing face recognition, in operation 507. The calculating of the face position by performing the face recognition is described above with reference to FIGS. 3 and 4A through 4E and thus detailed descriptions thereof will be omitted here.

Then, the digital signal processing unit 39 determines whether the face position corresponds to the desired position 100, in operation 509.

If the face position does not correspond to the desired position 100, the digital signal processing unit 39 directs the subject to move by outputting direction signals until the face position calculated by the face position corresponds to the desired position 100, in operation 511. FIG. 4D shows an example of how the subject is directed in accordance with the direction signals output from the digital signal processing unit 39. If the face position does not correspond to the desired position 100 as shown in FIG. 4D-1, the digital signal processing unit 39 outputs a direction signal to move the subject to the right. The direction signal is output to the LEDs 19-1, a right LED 19-1 is turned on, and then the photographer may move the subject to the right in response to the right LED 19-1. Alternatively, the direction signal is output to the speaker 25, the speaker 25 outputs a [Please move to the right] sound, and then the photographer may move the subject to the right in response to the sound.

If the face position does not yet correspond to the desired position 100 as shown in FIG. 4D-2, the digital signal processing unit 39 continuously outputs a direction signal to the LEDs 19-1 or the speaker 25 so as to direct the subject to move.

If the face position corresponds to the desired position 100 as shown in FIG. 4D-3, the digital signal processing unit 39 directs the photographer to capture a current live-view image in operation 513, and displays or stores the captured image in operation 515.

In more detail, if the face position corresponds to the desired position 100 as shown in FIG. 4D-3, the digital signal processing unit 39 may output a position correspondence signal to the LEDs 19-1 so as to turn all of the LEDs 19-1 on or off, or to the speaker 25 so as to output a [The position is correct now. Please press the shutter-release button] sound, thereby directing the photographer to capture the self-image. Then, the photographer presses the shutter-release button 11 illustrated in FIG. 1 so as to capture the self-image. As a result, an image shown in FIG. 4E is captured and stored.

As described above, according to the present invention, a self-image may be captured with a user-desired composition between a subject and a background, thereby maximizing satisfaction of a user.

While the present invention has been particularly shown and described with reference to exemplary embodiments thereof, it will be understood by those of ordinary skill in the art that various changes in form and details may be made therein without departing from the spirit and scope of the present invention as defined by the following claims.

Where software modules are involved, these software modules may be stored as program instructions or computer readable codes executable on the processor on a computer-readable media such as read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. This media can be read by the computer, stored in the memory, and executed by the processor.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements.

Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. Numerous modifications and adaptations will be readily apparent to those skilled in this art without departing from the spirit and scope of the present invention.

What is claimed is:

1. A digital image processing apparatus having a self-navigator function, the apparatus comprising:
a digital signal processing unit for setting a desired position at which a subject is to be positioned on a live-view image and directing the subject to move until an actual position of the subject corresponds to the desired position.

2. The apparatus of claim 1, further comprising a direction unit for outputting a visual signal or an audible signal in order to direct the subject to move.

3. The apparatus of claim 2, wherein the digital signal processing unit comprises:
a position setting unit for setting the desired position at which the subject is to be positioned on the live-view image;
a face recognition unit for calculating a face position of the subject on the live-view image;
a position determination unit for determining whether the face position corresponds to the desired position; and
a control unit for outputting direction signals to the direction unit until the face position corresponds to the desired position.

4. An operation method of a digital image processing apparatus having a self-navigator function, the method comprising:
receiving a signal for setting a desired position at which a subject is to be positioned on a live-view image;
calculating an actual position of the subject on the live-view image; and
directing the subject to move until the actual position of the subject corresponds to the desired position.

5. The method of claim 4, wherein a visual signal or an audible signal is output in order to direct the subject to move.

6. The method of claim 4, wherein the actual position of the subject is a face position of the subject, which is calculated by performing face recognition.

7. A computer program product, comprising a computer usable medium having a computer readable program code embodied therein, said computer readable program code adapted to be executed to implement a method for operating a digital camera, said method comprising:
receiving a signal for setting a desired position at which a subject is to be positioned on a live-view image;
calculating an actual position of the subject on the live-view image; and
directing the subject to move until the actual position of the subject corresponds to the desired position.
